(19) United States
(12) Patent Application Publication
(10) Pub. No.: US 2004/0229664 A1
(43) Pub. Date: Nov. 18, 2004

(54) Mobile communication device having extendable display

(75) Inventor: Lovleen Chadha, San Diego, CA (US)

Correspondence Address: Siemens Corporation, Attn: Elsa Keller, Legal Administrator, Intellectual Property Department, 170 Wood Avenue South, Iselin, NJ, 08830, US

(73) Assignee: Siemens Information and Communication Mobile LLC.

(21) Appl. No.: 10/642,082

(22) Filed: Aug. 14, 2003

Related U.S. Application Data
(63) Continuation-in-part of application No. 10/436,429, filed on May 12, 2003.

(51) Int. Cl. H04M 1/00

(52) U.S. Cl. 455/575.1

(57) ABSTRACT

A mobile communication device includes a display that may be extended to provide a larger display surface for displaying information to a user of the mobile communication device. The mobile communication device comprises a housing assembly including a first housing portion and a second housing portion. The second housing portion is interconnected with the first housing portion so that the second housing portion slides between a retracted position and an extended position. A display is positioned within the second housing portion so that at least a substantial portion of the display is held behind the first housing portion when the second housing portion is in the retracted position and at least a substantial portion of the display is viewable by a user of the mobile communication device when the second housing portion is in the extended position.

### CROSS-REFERENCE TO RELATED APPLICATIONS

The present application is a continuation-in-part of U.S. patent application Ser. No. 10/436,429, filed May 12, 2003, which is herein incorporated by reference in its entirety.

### BACKGROUND OF THE INVENTION

The present invention relates generally to mobile communication devices such as mobile telephones, pagers, wireless enabled palmtop computers, personal digital assistants (PDA), or the like, and more particularly, to a mobile communication device having a display that may be extended to provide a larger display surface for displaying information to a user of the mobile communication device.

Wireless mobile communication devices, in particular mobile telephones, typically include a keypad and a small display for displaying telephony related features (e.g., telephone numbers, caller identification, telephone functions). A typical mobile communication device, in particular a mobile telephone, is illustrated in FIG. 1. As shown, the mobile communication device 100 includes a housing 102 having a front face 104 that includes a keypad 106 and display 108. Because it is desirable to limit the overall size of the housing 102 of the mobile communication device 100, the area of the front face 104 available to the display 108 is limited. Consequently, the display 108 is typically only capable of displaying limited text or graphics.

Often mobile communication systems provide features or applications beyond simple telephony (e.g., Internet access, text messaging, gaming, and the like). It may be desirable for mobile communication devices employing such communication systems to display greater amounts of text or more complex graphics. As a result, the user, to fully take advantage of the features provided by such mobile communication devices, requires a larger display than is necessary for devices providing only simple telephony features.

One way of providing a larger display area for the mobile communication device is to eliminate the telephone keypad and utilize the entire front face of the mobile communication device as a display, overlaid with a touch sensitive panel or touch screen much like a conventional palmtop computer or personal digital assistant. A keypad may then be displayed by the display when telephony functions are used. However, while such mobile communication devices provide an impressive suite of functions (e.g., address books, calendars, Internet access, and the like) to the user, they are typically more expensive than mobile communication devices employing conventional keypads. Further, such mobile communication devices are somewhat less robust than conventional telephony only devices since the large, open display and touch screen are more susceptible to damage than would be a conventional keypad and smaller display.

A second way of providing a larger display area for the mobile communication device is to provide the device with a telephone keypad that may be extended and retracted from the housing of the device so that the keypad assembly slides beneath the display when not need. Thus, only the display and the most frequently used keys remain on the front face of the housing. In this manner, the mobile communication device may be provided with a more compact form factor, while accommodating a larger display and full size keypad. However, while this configuration provides many advantages over conventional designs and designs which eliminate the keypad entirely, many users desire immediate access to the keypad of the device over large display size.

Consequently, it is desirable to provide a mobile communication device having a display that may be extended from the housing of the mobile communication device to provide a larger display surface for displaying information to a user of the mobile communication device.

### SUMMARY OF THE INVENTION

The present invention is directed to a mobile communication device having a display that may be retracted or extended for providing a larger display surface for displaying information to a user of the mobile communication device.

In one embodiment, the mobile communication device comprises a housing and a display assembly. The display assembly is coupled to the housing so that the display assembly is movable between a retracted position, wherein the display assembly is retracted within a cavity formed in the housing, and an extended position wherein the display assembly is extended from the housing. The display assembly includes a display for displaying information to a user of the mobile communication device. In exemplary embodiments, a window disposed in the housing allows the user to view at least part of the display when the display assembly is retracted within the cavity. Displayed information is mapped to the display so that the information may be viewed through the window while the display assembly is retracted within the cavity. Alternatively, a second display may be provided, which may be semi-transparent to allow information provided by the display of the display assembly to be viewed therethrough.

In a second embodiment, the mobile communication device comprises a housing assembly including a first housing portion and a second housing portion. The second housing portion is interconnected with the first housing portion so that the second housing portion slides between a retracted position wherein the second housing portion is at least substantially disposed behind the first housing portion and an extended position wherein the second housing portion is at least partially extended from behind the first housing portion. A display is provided in the second housing portion for displaying information to a user of the mobile communication device. The display is positioned within the second housing portion so that at least a substantial portion of the display is held behind the first housing portion when the second housing portion is in the retracted position and at least a substantial portion of the display is viewable by a user of the mobile communication device when the second housing portion is in the extended position.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

FIG. 1 is an isometric view illustrating a conventional mobile communication device having a fixed display and keypad;

FIG. 2 is an isometric view illustrating a mobile communication device having an extendable display assembly in accordance with the present invention;

FIG. 3 is an isometric view of the mobile communication device shown in FIG. 2, wherein the extendable display assembly is shown in the extended position;

FIG. 4 is a partial isometric view of the mobile communication device shown in FIG. 2, further illustrating mapping of information to the display of the extendable display assembly;

FIGS. 5 and 6 are exploded isometric views of the mobile communication device shown in FIG. 2, further illustrating the pin assembly coupling of the extendable display assembly to the housing;

FIG. 7 is an isometric view illustrating a mobile communication device having an extendable display assembly in accordance with the present invention;

FIG. 8 is an isometric view of the mobile communication device shown in FIG. 7, wherein the extendable display assembly is shown in the extended position;

FIG. 9 is an isometric view illustrating a mobile communication device having an extendable display assembly in accordance with the present invention;

FIG. 10 is an isometric view of the mobile communication device shown in FIG. 9, wherein the extendable display assembly is shown in the extended position;

FIG. 11 is a partial isometric view of the mobile communication device shown in FIG. 9, further illustrating an exemplary extension mechanism;

FIG. 12 is an isometric view illustrating a mobile communication device having an extendable display assembly in accordance with the present invention;

FIGS. 13, 14 and 15 are isometric views of the mobile communication device shown in FIG. 12, illustrating extension and retraction of the extendable display assembly;

FIG. 16 is an isometric view illustrating a mobile communication device having a first, extendable display assembly and a second, fixed display in accordance with an exemplary embodiment of the present invention;

FIG. 17 is an isometric view of the mobile communication device shown in FIG. 16, wherein the extendable display assembly is shown in the extended position;

FIG. 18 is an isometric view illustrating a mobile communication device in accordance with the present invention that comprises a housing assembly including a first housing portion and a second housing portion having a display, wherein the second housing portion slides between a retracted position and an extended position with respect to the first housing portion to extend the display;

FIG. 19 is an isometric view of the mobile communication device shown in FIG. 18, wherein the second housing portion is shown in the extended position;

FIG. 20 is an isometric view illustrating a mobile communication device in accordance with the present invention that comprises a housing assembly including a first housing portion and a second housing portion having a display, wherein the second housing portion slides between an retracted position and an extended position with respect to the first housing portion to extend the display, and wherein the first housing portion is provided with a window through which a portion of the display may be viewed while the second housing portion is slid to the retracted position;

FIG. 21 is an isometric view of the mobile communication device shown in FIG. 20, wherein the second housing portion is shown in the extended position;

FIG. 22 is an isometric view illustrating a mobile communication device in accordance with the present invention that comprises a housing assembly including a first housing portion and a second housing portion having a display, wherein the second housing portion slides between a retracted position and an extended position with respect to the first housing portion to extend the display, and wherein the first housing portion is provided with a second display for displaying information to a user of the mobile communication device while the second housing portion is slid to the retracted position;

FIG. 23 is an isometric view of the mobile communication device shown in FIG. 22, wherein the second housing portion is shown in the extended position;

FIGS. 24 and 26 are isometric views illustrating mobile communication devices in accordance with the present invention that comprise housing assemblies including a first housing portion and a second housing portion having a display, wherein the second housing portion slides between a retracted position and an extended position with respect to the first housing portion to extend the display, and wherein the second housing portion is sized so that a portion of the display extends from behind the first housing portion for displaying information while the second housing portion is slid to the retracted position; and

FIGS. 25 and 27 are isometric views of the mobile communication devices shown in FIGS. 24 and 26, respectively, wherein the second housing portion is shown in the extended position.

### DETAILED DESCRIPTION OF SPECIFIC EMBODIMENTS

Reference will now be made in detail to the presently preferred embodiments of the invention, examples of which are illustrated in the accompanying drawings.

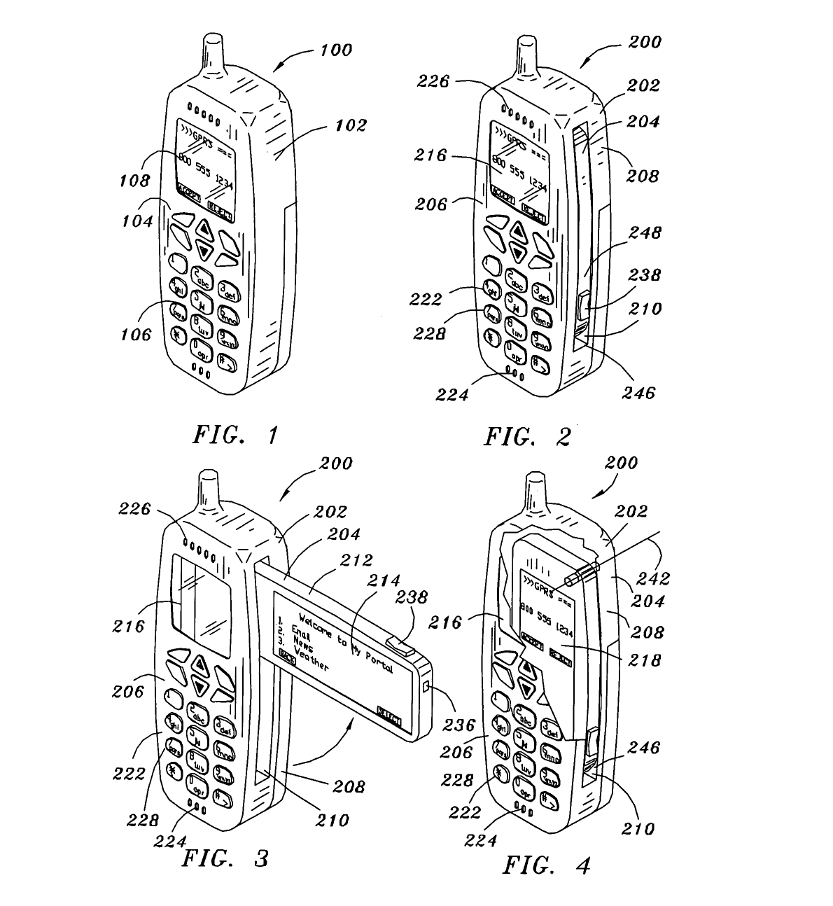

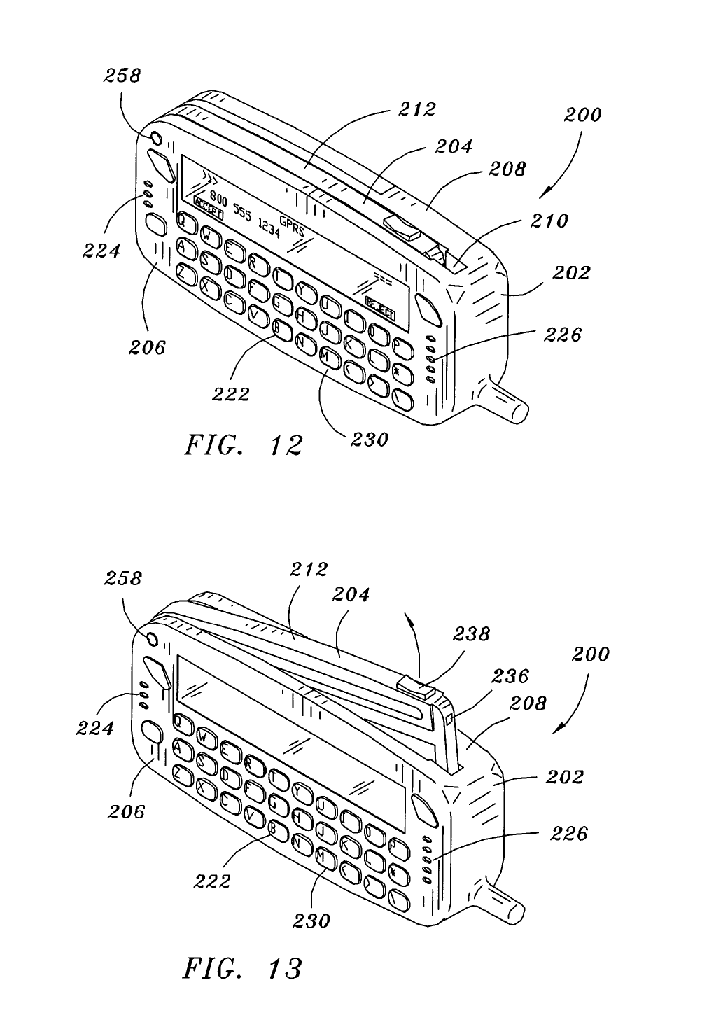

FIGS. 2 through 17 illustrate an exemplary mobile communication device 200 in accordance with the present invention. In FIGS. 2 through 17, the mobile communication device 200 includes a housing 202 having an extendable display assembly 204. The housing 202, which is generally sized to be held in the hand of a user of the mobile communication device 200, includes a front face 206 and a side surface 208 having an elongated cavity 210 formed therein. The display assembly 204 is coupled to the housing 202 so that the display assembly 204 may move between a retracted position, shown in FIGS. 2, 7, 9, 12 and 16, wherein the display assembly 204 is retracted within the cavity 210, and an extended position, shown in FIGS. 3, 8, 10, 15 and 17 wherein the display assembly is extended from the side surface 208 of the housing 202.

The display assembly 204 includes a support or frame 212 coupled to the housing 202, which mounts a display 214 for displaying information to users of the mobile communication device 200. In the exemplary embodiment illustrated, the display 214 comprises a color liquid crystal display (LCD). However, it is contemplated that the display 214 may employ any suitable flat panel display technology, including but are not limited to, monochromatic liquid crystal display (LCD) technologies, plasma display technologies, or polymer light emitting diode (PLED) technologies without departing from the scope and intent of the present invention. Moreover, the display 214 may include a touch sensitive overlay, digitizer, or touch screen to facilitate entry of data by the user via touch or stylus input.

In the embodiments of the mobile communication device 200 illustrated in FIGS. 2 through 15, a window 216 is provided in the front face 206 of the housing 202 to allow the user of the mobile communication device 200 to view a portion of the display 214 while the display assembly 204 is retracted within the cavity 210. Preferably, information displayed by the mobile communication device 200 while the display assembly 204 is in the retracted position is mapped (e.g., via software mapping the logical screen coordinates of the displayed information) to an area 218 of the display 214 that is positioned beneath the window 216 so that a user of the mobile communication device 200 may view the information through the window 216 without extending the display assembly 204.

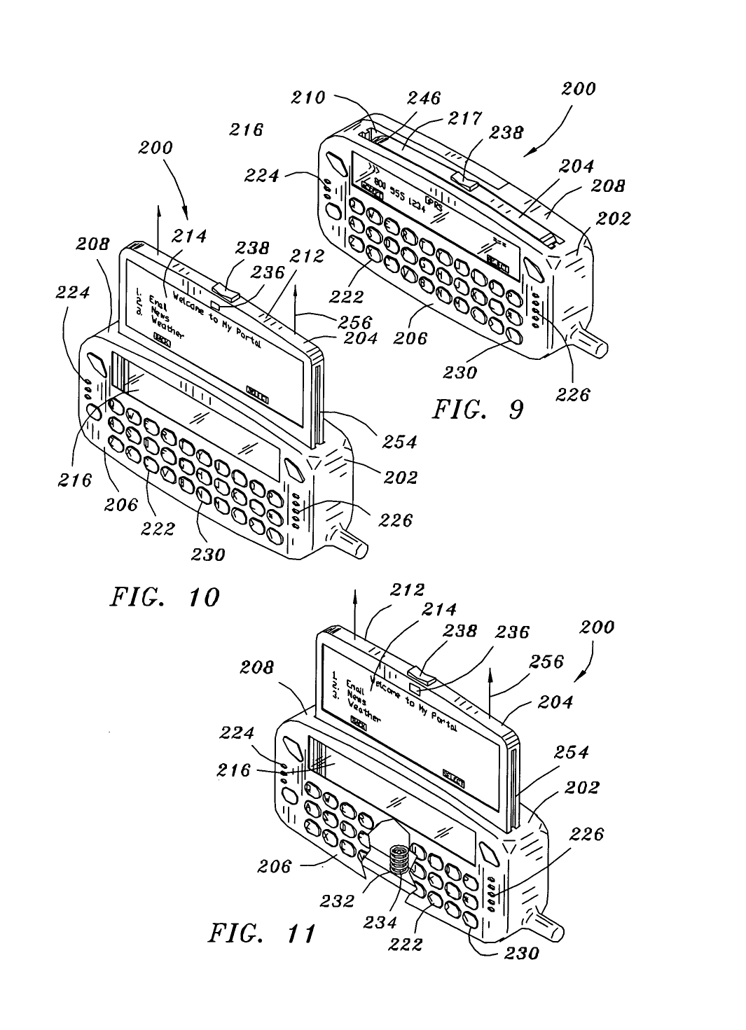

It will be appreciated that the area 218 of the display 220 viewable through the window 220 is limited by the area of the window 220, which is in turn limited by the area of the front face 206 of the housing 202. For example, the mobile communication devices 200 shown in FIGS. 2 through 8 employ a vertically oriented window 216 showing only a portion of the area of the display 24. In a specific example, the window 216 shows approximately thirty to forty percent (30-40%) of the area of the display 214. Thus, when the display assembly 204 is in the retracted position, approximately the upper thirty to forty percent (30-40%) of the display 214 is visible through the window 216 for the display of information. Likewise, the mobile communication devices 200 shown in FIGS. 9 through 15 employ a horizontally oriented window 216 showing only a portion of the area of the display (e.g., window 216 having an area of approximately ten to twenty percent (10-20%) of the area of the display 214 so that approximately ten to twenty percent (10-20%) of the display 214 is visible) when the display assembly 204 is in the retracted position. When the display assembly 204 is in the extended position, as shown in FIGS. 3, 8 and 15, displayed information is mapped to the full display 214 (i.e., the information may be displayed using all or any part of the display 214). Additionally, as shown in FIGS. 2 and 3, the orientation of the information displayed by the display 214 may be changed so that the information is displayed in a horizontal orientation with respect to the housing 202.

In exemplary embodiments, the window 216 may only allow a portion of the display 214 to be viewed while the display assembly 204 is in the retracted position. Consequently, it may be desirable to limit that amount and/or type of information 224 displayed by the display 214 while the display assembly 204 is in the retracted position. For example, the mobile communication device 200 may display only features requiring easy access by the user, such as information related to telephony functions of the mobile communication device 200, while the display assembly 204 is in the retracted position. Where access to more complex information such as Email, Internet browsing functions, gaming functions, calendar functions, or the like, is desired, the user may move the display assembly 204 to the extended position so that the entire display may be used to display the information.

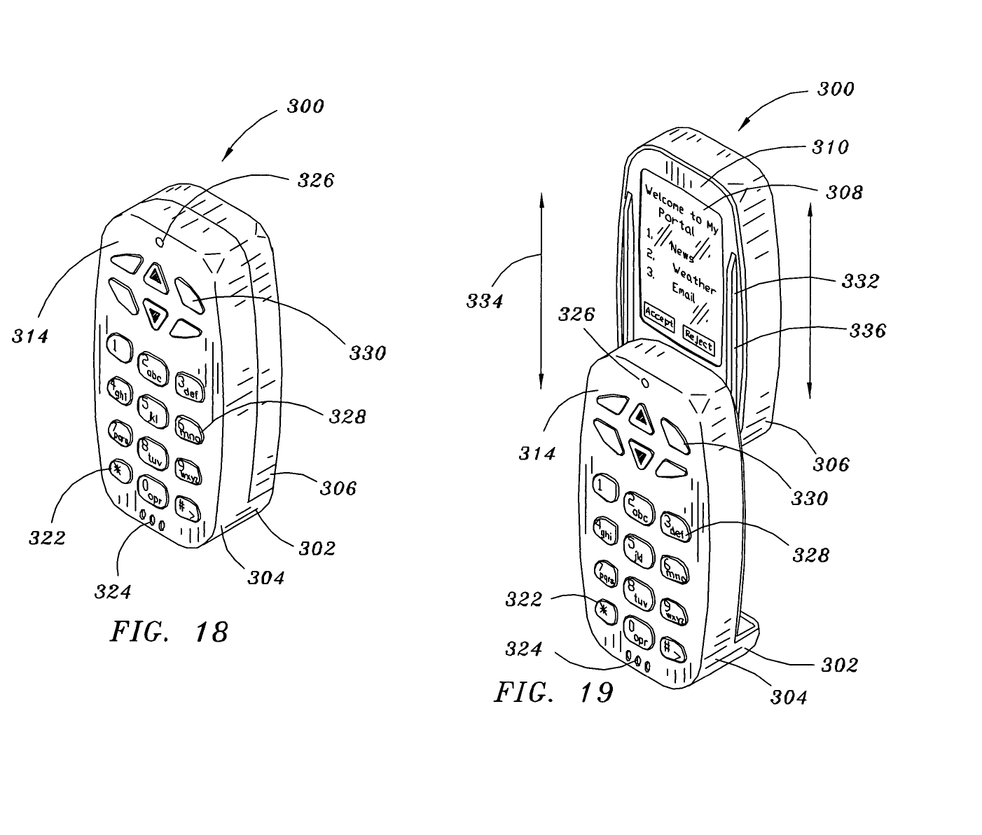

Alternatively, as shown in FIGS. 16 and 17, the mobile communication device 200 may include a second display 220 provided on the front face 206 of the housing 202 instead of the window 216. The second display 220 is employed for displaying information while the display assembly 204 is in the retracted position (shown in FIG. 16). When in the retracted position, the display assembly 204 may be shut off to conserve power when second display 220 is used. Alternatively, the second display 220 may be semi-transparent so that the display 214 of the display assembly 204 may be viewed through the second display 220 while the display assembly 204 is in the retracted position. In this manner, information provided by the second display 220 may be overlaid onto information provided by the display 214 of the display assembly 204. When the display assembly 204 is in the extended position, as shown in FIG. 17, information may be displayed by display 214 of the display assembly 204 alone with the second display 220 being shut off. Alternatively, information may be displayed by both the display 214 of the display assembly 204 and the second display 220. The displays 214 and 220 may display textual and graphical information contiguously.

In the embodiments illustrated, the mobile communication device 200 includes a keypad assembly 222 disposed in the front face 206 of the housing 202 adjacent to the window 216 (or second display 220), a microphone assembly 224 provided in the front face 206 of the housing 202 adjacent to and below the keypad assembly 222, and a speaker 226 positioned in the front face 206 of the housing adjacent to and above the window 216 (or second display 220). It is contemplated that the layout of keys of the keypad assembly 222 may be varied depending on design requirements of the particular mobile communication device 200. For example, in the vertically oriented mobile communication devices 200 of the embodiments illustrated in FIGS. 1 through 8, 16 and 17, the keypad assembly 222 comprises a conventional telephone keypad layout having function keys 228, while in the horizontally oriented mobile communication devices 200 of the embodiments illustrated in FIGS. 9 through 15, the keypad assembly comprises a QWERTY keyboard layout 230. Other key layouts are also possible.

The mobile communication device 200, which in a preferred embodiment comprises a mobile telephone, may further include components for providing wireless communication of voice and/or data information with external sources such as a base station, a cellular communication system tower, a second mobile communication device, or the like. For example, the mobile communication device 200 may comprise a processing assembly, memory, a transmitter/receiver assembly or transceiver, an antenna, a data card reader for receiving a data card (e.g., a subscriber identification module (SIM) card or a user identification module (UIM) card), a power source such as a battery, and the like. Additionally, it is contemplated that the mobile communication device 200 may provide functions other than telephony. For example, the mobile communication device 200 may provide functions common to hand held computers or personal digital assistants. In such embodiments, the mobile communication device may further include a suitable processing system, extended memory, a touch screen overlaying display 214 for tactile input of data, or the like.

The mobile communication device 200 may further include an extension mechanism 232 for extending the display assembly 204 from the retracted position. In exemplary embodiments, the extension mechanism 232 comprises a spring assembly 234 positioned within the cavity 210 which provides a biasing force that tends to move the display assembly 204 away from the fully retracted position to a partially extended position. The user of the mobile communication device 200 may then grasp the frame assembly 212 and manually move the display assembly 204 to the fully extended position. Alternatively, the extension mechanism 232 may comprise a drive mechanism that moves the display assembly 204 from the fully retracted position to the fully extended position without assistance from the user. A latching mechanism 236 may be provided for holding the display assembly 204 in the retracted position to prevent the display assembly 204 from being inadvertently extended. In exemplary embodiments, the latching mechanism 236 may include a button or slide 238, which, when actuated by the user of the mobile communication device 204, releases the display assembly 204, allowing the display assembly 204 to be extended by the extension mechanism 232. The latching mechanism may include a catch or pin, which may be beveled to ease engagement of the catch during retraction of the display assembly 204. Alternatively, where the extension mechanism 232 comprises a drive mechanism, the latching mechanism may be actuated electrically (e.g., via a solenoid, or the like).

FIGS. 1 through 6, 16 and 17 illustrate embodiments of the mobile communication device 200 wherein the display assembly 204 is pivoted or rotated between the retracted and extended positions much like a conventional folding knife (e.g., a pocket knife or switchblade knife). In these embodiments, the display assembly 204 is coupled to the housing 202 via a pin assembly 240 located within the cavity 210. The pin assembly 240 allows the display assembly 204 to pivot or rotate about an axis 242, coaxial with the pin assembly 240, which is substantially perpendicular to the front face 206 of the housing 202. The pin assembly 240 may further provide electrical connection between the display 214 and the processing system of the mobile communication device 200 for provision of electrical power to the display assembly 204 and transmission of display information to the display 214. In this manner, the display assembly 204 may pivot or rotate between the retracted position, shown in FIGS. 2 and 16, and the extended position, shown in FIG. 3 and 17.

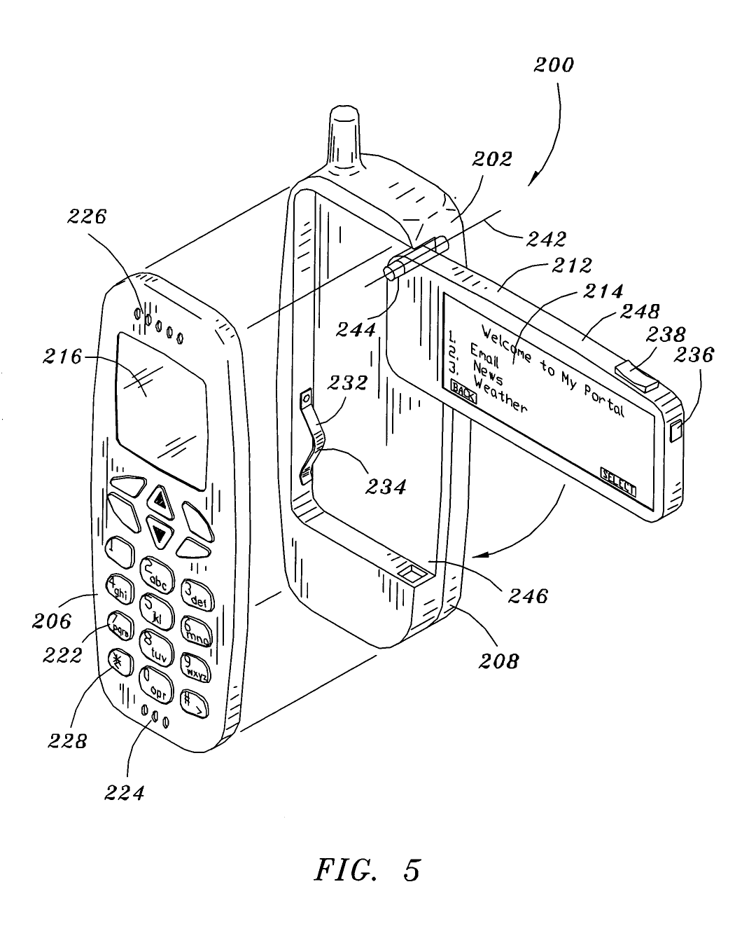

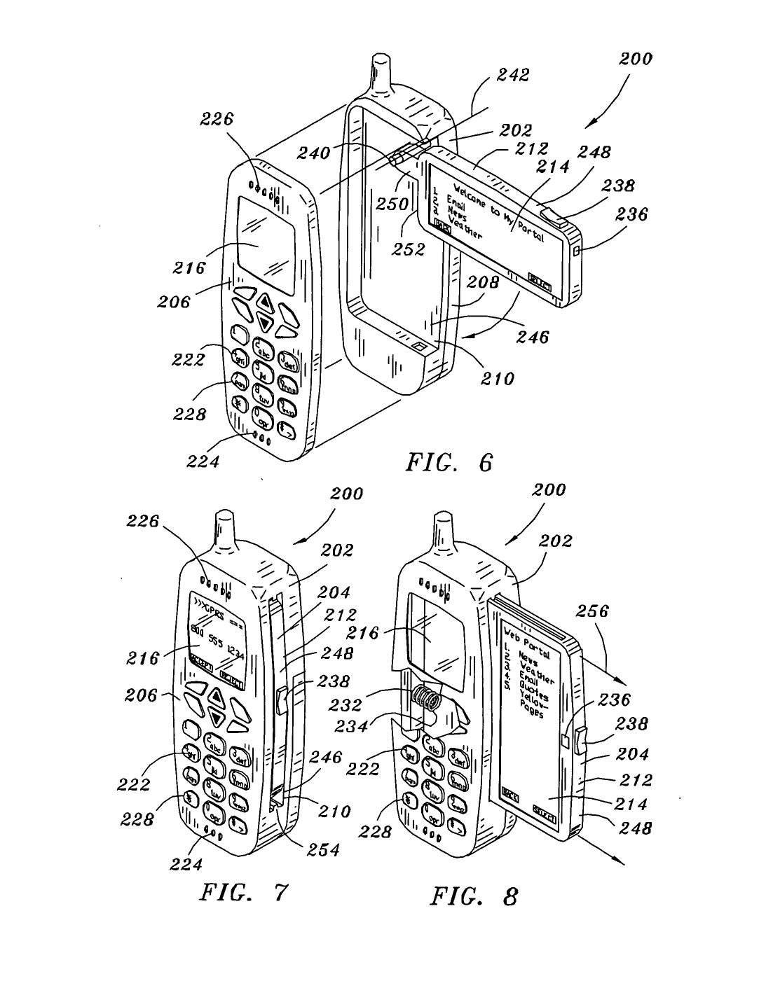

In such embodiments, the mobile communication device 200 may be configured to maximize the viewable area of the display 214 when the display assembly 204 is in the extended position. For example, as shown in FIGS. 4 and 5, the point where the pin assembly 240 connects to the display assembly 204 to the housing 202 may be located so that the axis of rotation 242 of the display assembly 204 is proximate to a corner 244 of the display assembly frame 212 that is adjacent to the opening 246 to the cavity 210. In this manner, the diameter of the arc through which the display assembly 204 rotates as the display assembly 204 pivots between the retracted position and the extended position is maximized for the volume available within the cavity 210. As a result, the display assembly 204 may accommodate a larger display 214 than would otherwise be possible. Additionally, by placing the pin assembly 216 at the corner 244 of the display assembly 204, the outer edge 248 of the display frame 212 may be sized to substantially fill the opening 246 to the cavity 210 while the display assembly 204 is in the retracted position. In this manner, the display frame assembly 212 may function to prevent contaminants such as moisture, dirt, debris, or the like from entering the cavity 210. Alternatively, the axis of rotation 242 may be moved further into the cavity 210. For example, as shown in FIG. 6, the display frame assembly 212 may include a lever arm portion 250 connecting display frame assembly 212 with the pin assembly 240 so that the axis of rotation 218 of the display assembly 204 is positioned along an edge 252 of the display frame assembly 212. Preferably, the lever arm portion 250 is sized to allow the entire display 214 to be visible to the user of the mobile communication device 200 when the display assembly 204 is rotated to the extended position, as shown in FIG. 4, while allowing the display 214 to be positioned under the window 216 (or semi-transparent display 220) while the display assembly 204 is in the retracted position.

FIGS. 7 though 11 illustrate embodiments of the mobile communication device 200 wherein the display assembly 204 slides between the retracted and extended positions. In these embodiments, the display assembly 204 is coupled to the housing 202 via a rail or track assembly 254 that extends along the edges of the display assembly frame 212. The track assembly 254 allows the display assembly 204 to slide between the retracted position, shown in FIGS. 7 and 9, and the extended position, shown in FIGS. 8, 10 and 11, along a plane, indicated by arrowed lines 256, that is substantially parallel with the front face 206 of the housing 202. In the embodiment shown in FIGS. 7 and 8, the window 216 (or, alternatively, a second display) and keypad assembly 222 are oriented vertically on the front face 206 of the housing 202. The display assembly 204 extends from a side of the housing 202. Alternatively, in the embodiment shown in FIGS. 9 through 11, the window 216 (or second display) and keypad assembly 222 are oriented horizontally on the front face 206 of the housing 202. The display assembly 204 thus extends from the top (or, alternatively, the bottom) of the housing 202.

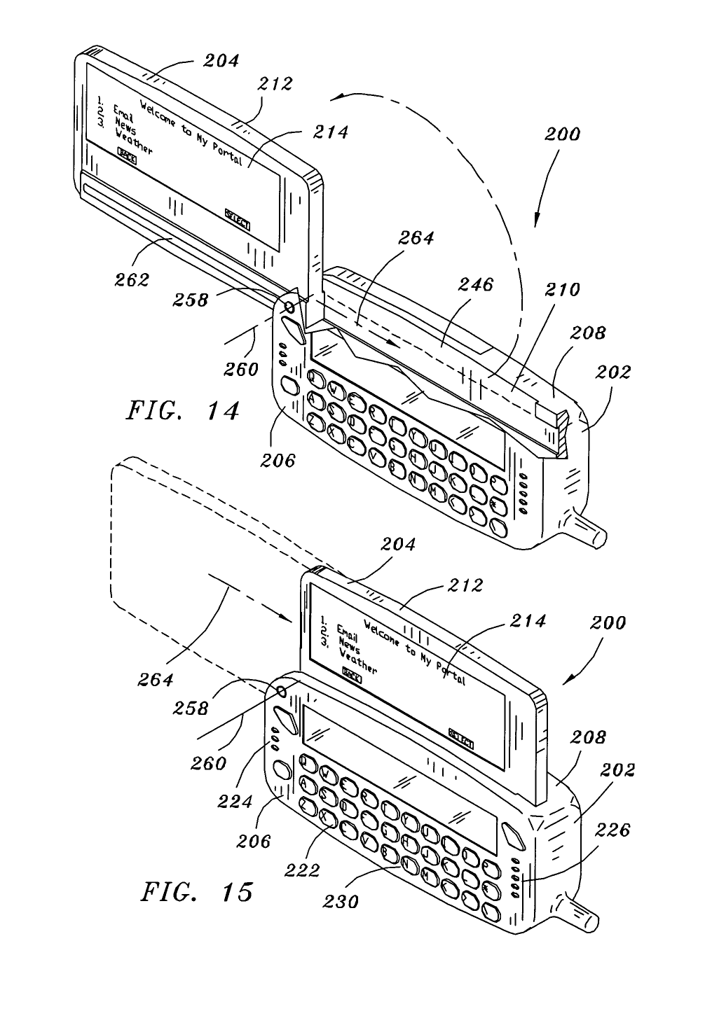

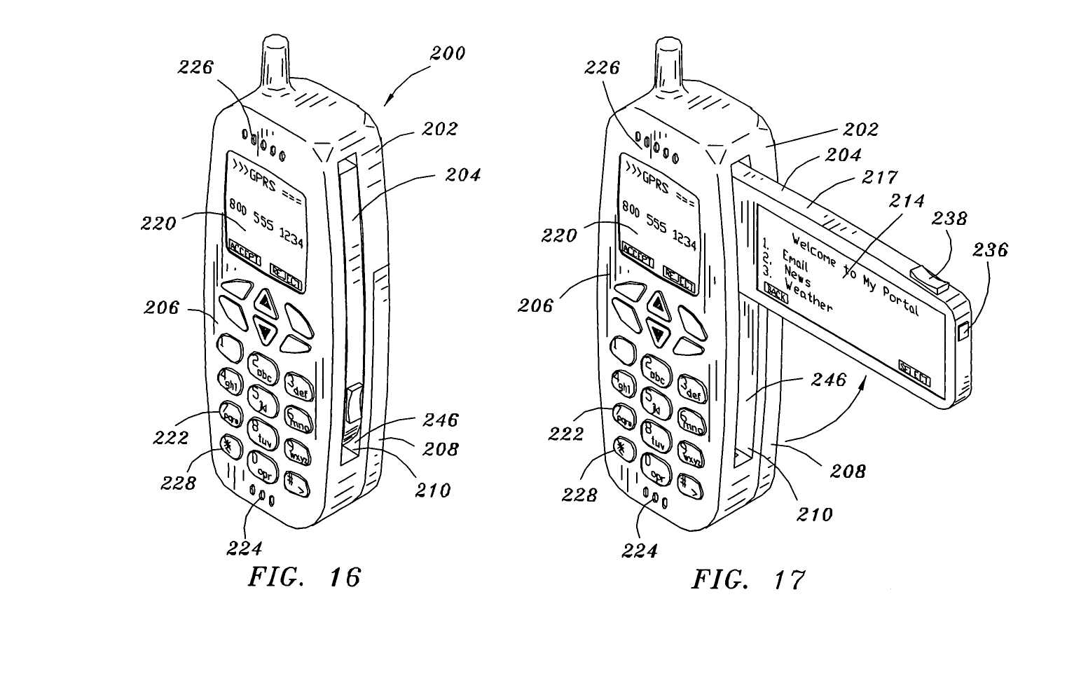

FIGS. 12 though 15 illustrate an embodiment of the mobile communication device 200 wherein the display assembly 204 pivots or rotates between the retracted position and an intermediate position, and then slides between the intermediate position and the extended position. In this embodiment, the display assembly 204 is coupled to the housing 202 via a pin assembly 258, which may provide electrical connection between the display 214 and components such as the processing system and power supply of the mobile communication device 200. To extend the display assembly 204, the pin assembly 258 allows the display assembly 204 to pivot or rotate about an axis 260, coaxial with the pin assembly 258, which is substantially perpendicular to the front face 206 of the housing 202. In this manner, the display assembly 204 may pivot or rotate from the retracted position, shown in FIG. 12, to the intermediate position, shown in FIG. 14, wherein the display assembly 14 is extended away from the housing 202 but is not aligned with the keypad 222. The pin assembly 258 may then move along track 260 so that the display assembly 204 may slide to the extended position, shown in FIG. 15, along a plane, indicated by arrowed line 264, which is substantially parallel to the front face 206 of the housing 202. In this manner, the display 214 is substantially aligned with the keypad assembly 222 while the display assembly 204 is in the extended position. The edge of the display assembly 204 may interface with a track in the housing 202 to keep the display assembly 204 oriented substantially parallel to the housing 202 while the display assembly 204 is in the extended position. Preferably, as the display assembly 204 is moved to the extended position, software or firmware automatically changes the orientation of information displayed by the display 214 so that the information is displayed in an upright orientation relative to the keypad 222. For example, in one embodiment, software or firmware may remap the logical coordinates of the information so that the orientation of the information is flipped vertically on the display 214. To retract the display assembly 204, the display assembly 204 is slid from the extended position, shown in FIG. 15, to the intermediate position, shown in FIG. 14, and then pivoted or rotated back to the retracted position, shown in FIG. 12.

In the embodiment shown in FIGS. 12 through 15, the window 216 (or alternatively a second display) and keypad assembly 222 are oriented horizontally on the front face 206 of the housing 202. The display assembly 204 thus extends from the top (or, alternatively the bottom) of the housing 202. However, it will be appreciated that display assemblies 204 in accordance with this embodiment (i.e., display assemblies 204 which pivot and slide between the retracted and extended positions) may also be implemented in mobile communication devices 200 wherein the window 216 (or alternatively the second display) and keypad assembly 222 are oriented vertically.

In FIGS. 2 through 17, the display assembly 204 is illustrated as extending either to the right side of the housing 202 of the mobile communication device 200 (FIGS. 2 though 10, 16 and 17), or to the top of the housing 202 of the mobile communication device 200 (FIGS. 11 through 15). However, it is contemplated that, in other embodiments, the display assembly 204 may alternatively extend to the left side of the housing 202, or, may alternately extend to either side of the housing 202 depending, for example, on whether the user was right or left handed without departing from the scope and intent of the present invention.

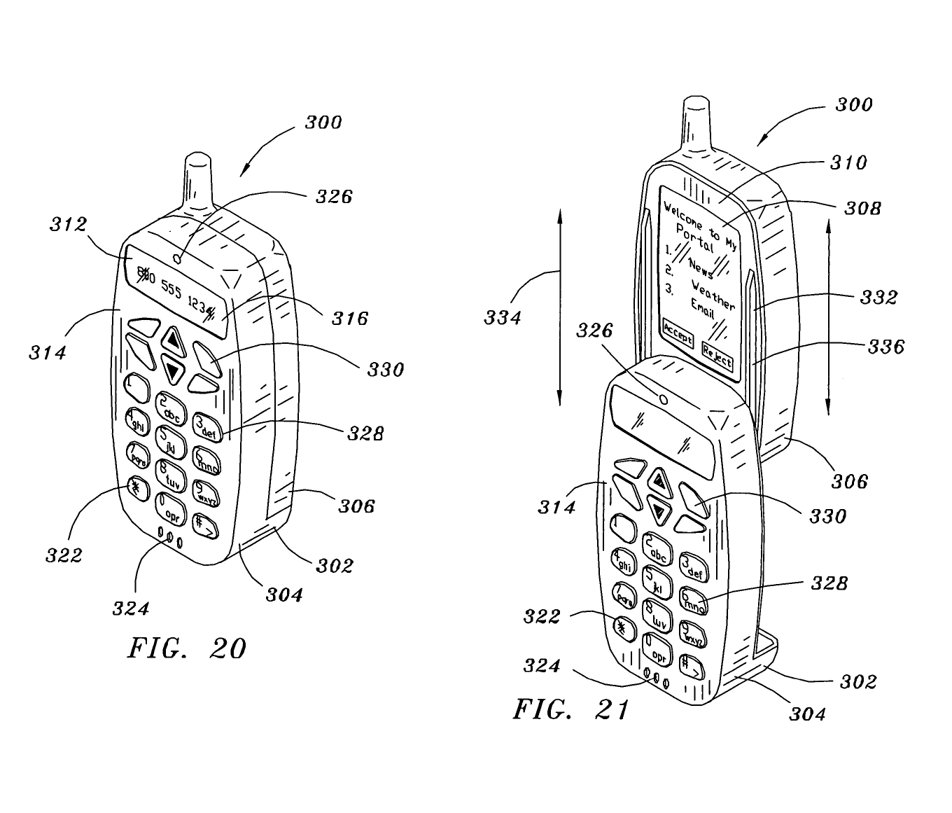

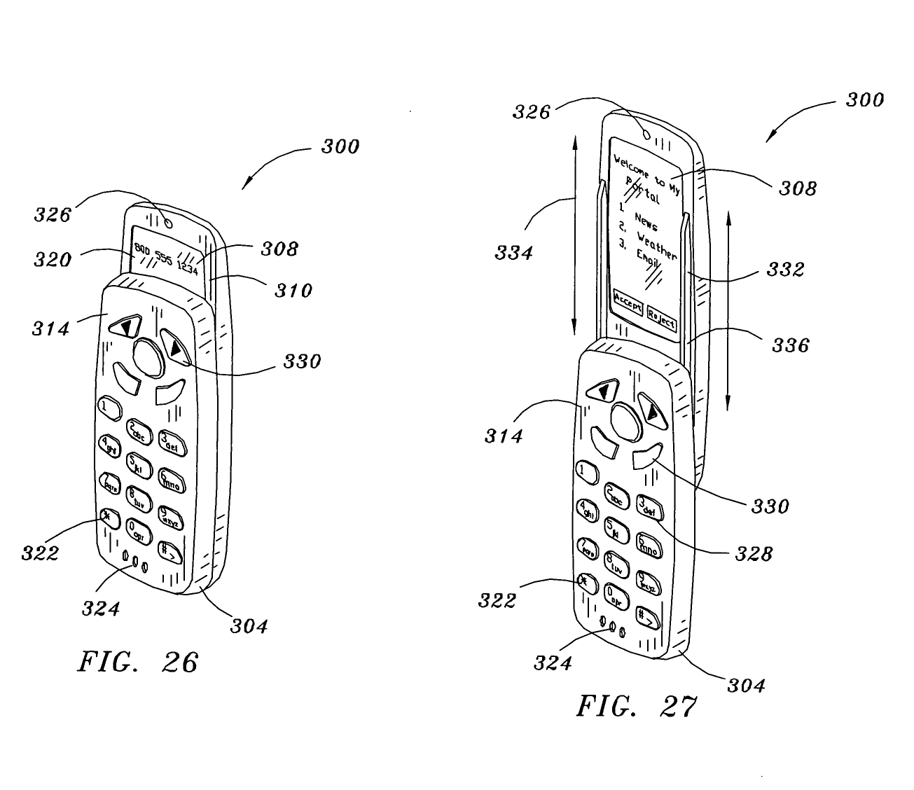

FIGS. 18 through 27 illustrate a second exemplary mobile communication device 300 in accordance with the present invention. In FIGS. 18 through 27, the mobile communication device 300 includes a housing assembly 302 which is generally sized to be held in the hand of a user of the mobile communication device 300. The housing assembly 302 includes a first housing portion 304 and a second housing portion 306. The second housing portion 306 is interconnected with the first housing portion 304 so that the second housing portion slides between a retracted position, shown in FIGS. 18, 20, 22, 24 and 26, wherein the second housing portion 306 is held or positioned at least substantially behind the first housing portion 304 and an extended position, shown in FIGS. 19, 21, 23, 25 and 27, wherein the second housing portion 306 is at least partially extended from behind the first housing portion 304. A display 308 is provided in the front face 310 of the second housing portion 306 for displaying information to a user of the mobile communication device 300. Preferably, the display 308 is positioned within the second housing portion 306 so that all or at least a substantial portion of the display 308 is held behind the first housing portion 304 while the second housing portion 306 is in the retracted position and all or at least a substantial portion of the display 308 is viewable by a user of the mobile communication device 300 when the second housing portion 306 is in the extended position.

In the embodiment of the mobile communication device 300 illustrated in FIGS. 20 and 21, a window 312 is provided in the front face 314 of the first housing portion 304 to allow the user of the mobile communication device 300 to view a portion of the display 308 while the second housing portion 306 is in the retracted position. Preferably, information displayed by the mobile communication device 300 while the second housing portion 306 is in the retracted position is mapped (e.g., via software mapping the logical screen coordinates of the displayed information) to an area 316 of the display 308 that is positioned beneath the window 312. In this manner, a user of the mobile communication device 300 may view the information through the window 312 without extending the second housing portion 306.

It will be appreciated that the area 316 of the display 308 viewable through the window 312 is limited by the area of the window 312, which is in turn limited by the area of the front face 314 of the first housing portion 304. For example, the mobile communication device 300 shown in FIGS. 20 and 21 employs a vertically oriented window 312 showing only a portion of the area of the display 308. In a specific example, the window 312 shows approximately twenty to thirty percent (20-30%) of the area of the display 308. Thus, when the first housing portion 306 is in the retracted position, approximately the upper twenty to thirty percent (20-30%) of the display 308 is visible through the window 312 for the display of information. When the second housing portion 306 is in the extended position, as shown in FIG. 21, displayed information is mapped to the full display 308 (i.e., the information may be displayed using all or any part of the display 308).

Because the window 312 allows only a portion of the display 308 to be viewed while the second housing portion 306 is in the retracted position, it is contemplated it may be desirable to limit that amount and/or type of information displayed by the display 308 while the second housing portion 306 is in the retracted position. For example, the mobile communication device 300 may display only features requiring easy access by the user, such as information related to telephony functions of the mobile communication device 300 (e.g., a caller identification, a numeric page, a dialed telephone number, or the like) within the window 312 while the second housing portion 306 is in the retracted position. Where access to more complex information such as Email, Internet browsing functions, gaming functions, calendar functions, text messaging (e.g., SMS (Short Message Service) or MMS (Mail Management System) messages), or the like, is desired, the user may slide the second housing portion 306 to the extended position so that the entire display 308 may be viewed thereby allowing the entire display 308 to be used to display the information.

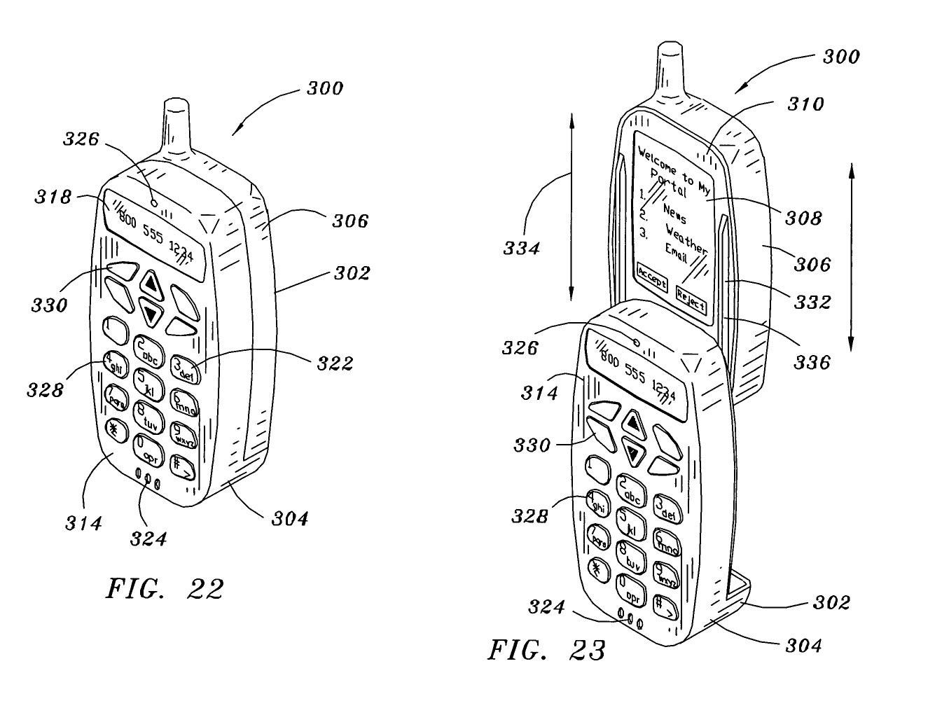

In the embodiment illustrated in FIGS. 22 and 23, the mobile communication device 300 may include a second display 318 provided on the front face 314 of the first housing portion 304 instead of the window 312. The second display 318 is employed for displaying information while the second housing portion 306 is in the retracted position (shown in FIG. 22). While in the retracted position, the display 308 may be shut off to conserve power. Alternatively, the window 312 may comprise a second display 318 that is semi-transparent so that the first display 308 may be viewed through the second display 318 while the second housing portion 306 is in the retracted position. In this manner, information provided by the second display 318 may be overlaid onto information provided by the fist display 308. While the second housing portion 306 is in the extended position, as shown in FIG. 23, information may be displayed either by first display 308 alone, with the second display 318 being shut off, or by both the first display 308 and the second display 318. The displays 308 and 318 may also display textual and graphical information contiguously.

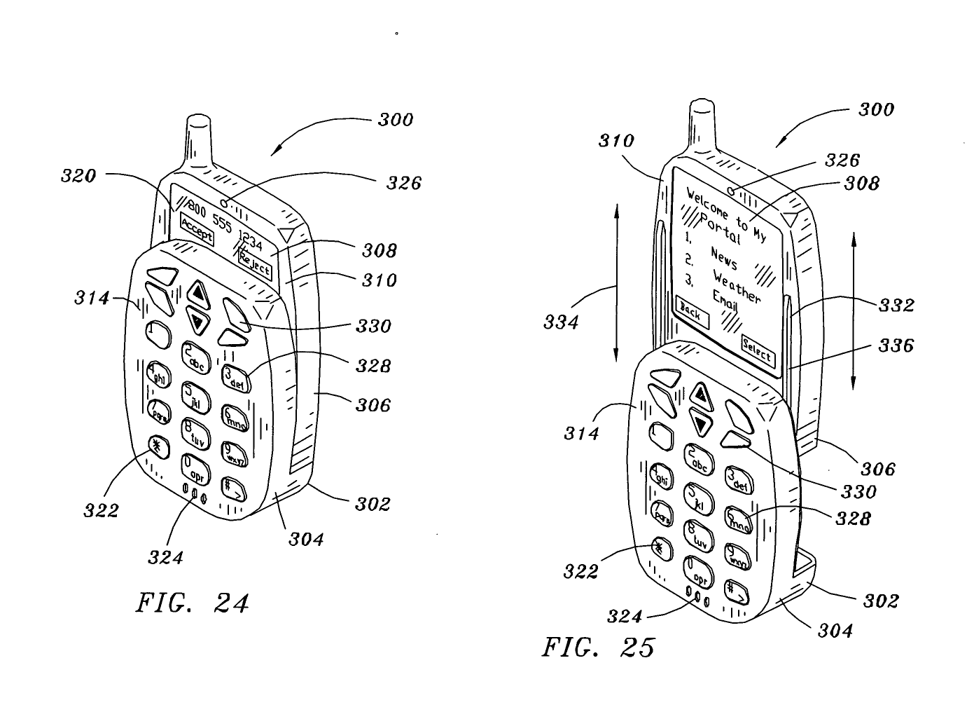

In the embodiment of the mobile communication device 300 illustrated in FIGS. 24 through 27, the first housing portion 304 is smaller than the second housing portion 306 so that an area 320 within the upper portion of the display 308 extends from behind the first housing portion 304 while the second housing portion 306 is in the retracted position and is visible to the user of the mobile communication device 300. When the second housing portion 306 is in the extended position, as shown in FIGS. 25 and 27, displayed information is mapped to the full display 308 (i.e., the information may be displayed using all or any part of the display 308). However, while the second housing portion 306 is in the retracted position, information displayed by the mobile communication device 300 is mapped (e.g., via software mapping the logical screen coordinates of the displayed information) to the display 308 so that the information is visible to the user within the visible upper portion of the display 308 without extending the second housing portion 304.

It is contemplated that the area 320 of the display 308 visible or viewable while the second housing portion 306 is in the retracted position is dependent on design considerations such as the size of the display, the relative sizes of the first housing portion 304 and 306, and the overall size of the mobile communication device, the kinds of information to be displayed, and the like. For example, for the mobile communication devices 300 shown in FIGS. 24 through 27, approximately twenty to thirty percent (20-30%) of the area of the display 308 extends from behind the first housing portion 304 while the second housing portion is in the retracted position. Consequently, approximately the upper twenty to thirty percent (20-30%) of the display 308 is visible for the display of information. Because only a portion of the display 308 to be viewed while the second housing portion 306 is in the retracted position, it is again contemplated it may be desirable to limit that amount and/or type of information displayed by the display 308 while the second housing portion 306 is in the retracted position. Thus, the mobile communication device 300 may display only features requiring easy access by the user, such as information related to telephony functions of the mobile communication device 300 (e.g., a caller identification, a numeric page, a dialed telephone number, or the like) within the visible area 320 of the display 308 while the second housing portion 306 is in the retracted position. Where access to more complex information such as Email, Internet browsing functions, gaming functions, calendar functions, text messaging (e.g., SMS (Short Message Service) or MMS (Mail Management System) messages), or the like, is desired, the user may slide the second housing portion 306 to the extended position so that the entire display 308 may be viewed thereby allowing the entire display 308 to be used to display the information.

In the embodiments illustrated in FIGS. 18 through 27, the mobile communication device 300 further includes a keypad assembly 322 disposed in the front face 314 of the first housing portion 304, a microphone assembly 324 provided in the front face 314 of the first housing portion 304 adjacent to and below the keypad assembly 322, and a speaker assembly 326, which may be provided in the front face 314 of the first housing portion 304, and may be positioned adjacent to and above the keypad assembly 322, window 312 or second display 318 (see FIGS. 18 through 23), or, alternatively, in the front face 310 of the second housing portion 306 adjacent too and above the first display 308 (see FIGS. 24 through 27). It is contemplated that the layout of keys of the keypad assembly 322 may be varied depending on design requirements of the particular mobile communication device 200. For example, in the vertically oriented mobile communication devices 200 of the embodiments illustrated in FIGS. 18 through 25, the keypad assembly 322 comprises a conventional telephone keypad layout 328 having function keys 330. Other key layouts, including QWERTY keyboard layouts, and the like, are also possible.

Like the mobile communication device 200 described in the discussion of FIGS. 2 through 17, the mobile communication device 300 may, in a preferred embodiment, comprise a mobile telephone, and may include components for providing wireless communication of voice and/or data information with external sources such as a base station, a cellular communication system tower, a second mobile communication device, or the like. For example, like the mobile communication device 200, the mobile communication device 300 may comprise a processing assembly, memory, a transmitter/receiver assembly or transceiver, an antenna, a data card reader for receiving a data card (e.g., a subscriber identification module (SIM) card or a user identification module (UIM) card), a power source such as a battery, and the like. Additionally, it is contemplated that the mobile communication device 200 may provide functions other than telephony. For example, the mobile communication device 200 may provide functions common to hand held computers or personal digital assistants. In such embodiments, the mobile communication device may further include a suitable processing system, extended memory, a touch screen overlaying display 308 for tactile input of data, or the like.

In the exemplary embodiments illustrated in FIGS. 18 through 27, the second housing portion 306 is coupled to the first housing portion 304 via a slide assembly 332 which interconnects the second housing portion 306 with the first housing portion 304. The slide assembly allows the second housing portion to slide between the retracted position, and the extended position, along a plane, indicated by arrowed lines 334, that is at least substantially parallel with the front face 314 of the first housing portion 304 and the front face 310 of the second housing portion 306. As shown in FIGS. 19, 21, 23 and 25, the slide assembly 312 includes one or more tracks 336, tabs, posts, or the like, provided on the front face 310 of the second housing portion 306. The tracks 336 engage channels or like structures formed on the back surface of the first housing portion 304 so that the tracks 324 may slide in the channels. However, those of ordinary skill in the art will recognize that slide assemblies suitable for interconnecting the first and second housing portions 304 and 306 are not limited to the specific configuration illustrated, and that the mobile communication device 300 may employ slide assemblies having a variety of other geometries and configurations without departing from the scope and intent of the present invention. For example, in one embodiment, tracks may be provided on the back surface of the first housing portion 304 to engage channels formed on the front face 310 of the second housing portion 306. Similarly, tracks may be placed on the side surfaces of one of the first housing portion 304 or the second housing portion 306. The side surfaces of other housing portion 306 or 304 may then be formed to extend over the side surfaces to engage the tracks. The mobile communication device 300 may further include a latching mechanism for holding the second housing portion 306 in the retracted position. In exemplary embodiments, the latching mechanism may be overcome by the user of the mobile communication device 300 allowing the user to extend the second housing portion 306 to the extended position.

In the embodiments of the invention shown in FIGS. 18 through 27, the first and second housing portions 304 and 306 are oriented so that the second housing portion 306 slides vertically upward with respect to first housing portion 304 while the first housing portion 304 slides downward with respect to the second housing portion 306. This arrangement allows the display 308 to be placed above the keypad assembly 322 while the second housing portion 306 is in the extended position, as is customary in mobile communications devices 300 such as mobile telephones, or the like. Nevertheless, it is contemplated that in embodiments of the mobile communication device 300, the second housing portion 306 may extend either to the right or left sides of the first housing portion 304, may alternately extend to either side of the first housing portion 304 (depending, for example, on whether the user was right or left handed), or, may extend to the bottom of the first housing portion 304 as viewed by a user of the mobile communication device 300 without departing from the scope and intent of the present invention.

For purposes of illustration, the embodiments of the mobile communication devices 200 and 300 illustrated in FIGS. 2 through 27 are exemplary, and are thus shown in “brick” form with ornate features eliminated. However, those of ordinary skill in the art will recognize that mobile communication devices in accordance with the present invention are not limited to the specific configurations disclosed herein, but instead may employ form factors having other ornamental or functional design features without departing from the scope and intent of the present invention.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A mobile communication device, comprising:
a housing assembly including a first housing portion and a second housing portion, the second housing portion being interconnected with the first housing portion so that the second housing portion slides between a retracted position wherein the second housing portion is substantially disposed behind the first housing portion and an extended position wherein the second housing portion is at least partially extended from behind the first housing portion; and
a display disposed in the second housing portion for displaying information to a user of the mobile communication device,
wherein display is positioned within the second housing portion so that at least a substantial portion of the display is held behind the first housing portion when the second housing portion is in the retracted position and at least a substantial portion of the display is viewable by a user of the mobile communication device when the second housing portion is in the extended position.

2. The mobile communication device as claimed in claim 1, further comprising a keypad assembly disposed in the first housing portion.

3. The mobile communication device as claimed in claim 1, further comprising:
a window disposed in the first housing portion for allowing the user to view at least part of the display while the second housing portion is in the retracted position,
wherein the displayed information is mapped to the display so that the information is viewable through the window while the second housing portion is in the retracted position.

4. The mobile communication device as claimed in claim 3, further comprising a keypad disposed in the first housing portion adjacent to the window.

5. The mobile communication device as claimed in claim 3, wherein the window comprises a second display, the second display being semi-transparent so that information displayed by the display is viewable through the window.

6. The mobile communication device as claimed in claim 3, wherein the displayed information is mapped to an area of the display within the window while the second housing portion is in the retracted position, and wherein the displayed information is mapped to the full display while the second housing portion is in the extended position.

7. The mobile communication device as claimed in claim 1, wherein a portion of the display extends from behind the first housing portion while the second housing portion is in the retracted position.

8. The mobile communication device as claimed in claim 7, wherein the displayed information is mapped to the portion of the display extending from behind the first housing portion while the second housing portion is in the retracted position, and wherein the displayed information is mapped to the full display while the second housing portion is in the extended position.

9. The mobile communication device as claimed in claim 7, further comprising a keypad disposed in the first housing portion.

10. The mobile communication device as claimed in claim 1, further comprising a second display disposed in the first housing portion.

11. The mobile communication device as claimed in claim 10, further comprising a keypad disposed in the first housing portion.

12. A mobile telephone, comprising:
a housing assembly including a first housing portion and a second housing portion, the second housing portion being interconnected with the first housing portion so that the second housing portion slides between a retracted position wherein the second housing portion is substantially disposed behind the first housing portion and an extended position wherein the second housing portion is at least partially extended from behind the first housing portion; and
a display disposed in the second housing portion for displaying information to a user of the mobile communication device,
wherein display is positioned within the second housing portion so that at least a substantial portion of the display is held behind the first housing portion when the second housing portion is in the retracted position and at least a substantial portion of the display is viewable by a user of the mobile communication device when the second housing portion is in the extended position.

13. The mobile telephone as claimed in claim 12, further comprising a keypad assembly disposed in the first housing portion.

14. The mobile telephone as claimed in claim 12, further comprising:
a window disposed in the first housing portion for allowing the user to view at least part of the display while the second housing portion is in the retracted position,
wherein the displayed information is mapped to the display so that the information is viewable through the window while the second housing portion is in the retracted position.

15. The mobile telephone as claimed in claim 14, further comprising a keypad disposed in the first housing portion adjacent to the window.

16. The mobile telephone as claimed in claim 14, wherein the window comprises a second display, the second display being semi-transparent so that information displayed by the display is viewable through the window.

17. The mobile telephone as claimed in claim 14, wherein the displayed information is mapped to an area of the display within the window while the second housing portion is in the retracted position, and wherein the displayed information is mapped to the full display while the second housing portion is in the extended position.

18. The mobile telephone as claimed in claim 12, wherein a portion of the display extends from behind the first housing portion while the second housing portion is in the retracted position.

19. The mobile telephone as claimed in claim 18, wherein the displayed information is mapped to the portion of the display extending from behind the first housing portion while the second housing portion is in the retracted position, and wherein the displayed information is mapped to the full display while the second housing portion is in the extended position.

20. The mobile telephone as claimed in claim 18, further comprising a keypad disposed in the first housing portion.

21. The mobile telephone as claimed in claim 12, further comprising a second display disposed in the first housing portion.

22. The mobile telephone as claimed in claim 21, further comprising a keypad disposed in the first housing portion.

23. A mobile communication device, comprising:
a housing assembly including a first housing portion and a second housing portion, the second housing portion being interconnected with the first housing portion;
means for sliding the second housing portion between a retracted position wherein the second housing portion is substantially disposed behind the first housing portion and an extended position wherein the second housing portion is at least partially extended from behind the first housing portion; and
means, disposed in the second housing portion, for displaying information to a user of the mobile communication device,
wherein displaying means is positioned within the second housing portion so that at least a substantial portion of the display means is held behind the first housing portion when the second housing portion is in the retracted position and at least a substantial portion of the displaying means is viewable by a user of the mobile communication device when the second housing portion is in the extended position.

24. The mobile communication device as claimed in claim 23, further comprising means, disposed in the first housing portion, for keying information into the mobile communication device.

25. The mobile communication device as claimed in claim 23, further comprising:
means, disposed in the first housing portion, for viewing at least part of the display means while the second housing portion is in the retracted position,
wherein the displayed information is mapped to the display means so that the information is viewable through the viewing means while the second housing portion is in the retracted position.

26. The mobile communication device as claimed in claim 25, wherein the displayed information is mapped to an area of the display means within the viewing means while the second housing portion is in the retracted position, and wherein the displayed information is mapped to the full display means while the second housing portion is in the extended position.

27. The mobile communication device as claimed in claim 23, wherein a portion of the display means extends from behind the first housing portion while the second housing portion is in the retracted position.

28. The mobile communication device as claimed in claim 27, wherein the displayed information is mapped to the portion of the display means extending from behind the first housing portion while the second housing portion is in the retracted position, and wherein the displayed information is mapped to the full display means while the second housing portion is in the extended position.

29. The mobile communication device as claimed in claim 23, further comprising second means, disposed in the first housing portion, for displaying information to the user.
